(19) United States
(12) Patent Application Publication
(10) Pub. No.: US 2008/0248704 A1
(43) Pub. Date: Oct. 9, 2008

(54) Finished Fibers and Textile Construction

(76) Inventors: Raymond Mathis, Duesseldorf (DE); Hans-Juergen Sladek, Krefeld (DE); Markus Fuelleborn, Duesseldorf (DE); Shefqet Emini, Duesseldorf (DE)

Correspondence Address: SYNNESTVEDT & LECHNER LLP, 1101 MARKET STREET, PHILADELPHIA, PA, 19107, US

(21) Appl. No.: 11/659,412

(22) PCT Filed: Jul. 26, 2005
(86) PCT No.: PCT/EP05/08092

§ 371 Date: Mar. 27, 2008

(30) Foreign Application Priority Data
Aug. 4, 2004 (DE) 10 2004 037 752.9

(51) Int. Cl. B32B 27/04; D06M 23/12; D06M 15/00

(52) U.S. Cl. 442/102; 427/430.1; 523/210

(57) ABSTRACT

The invention relates to fibers and textile fabrics which have been impregnated with a mixture containing a hydrophobic active component and a polymer binder to improve wearer comfort.

### CROSS-REFERENCE TO RELATED APPLICATIONS

This application is filed under 35 U.S.C. § 371 claiming priority from Application PCT/EP2005/008092 filed on Jul. 26, 2005, which claims priority of German Application No. 10 2004 037 752.9 filed Aug. 4, 2004, the entire contents of which are incorporated herein by reference.

### FIELD OF THE INVENTION

This invention relates generally to the field of textiles and, more particularly, to new finished fibers and textile fabrics with improved wearing comfort, to processes for their production and to the use of mixtures of active components and binders for finishing textiles.

### BACKGROUND OF THE INVENTION

The term “wearing comfort” encompasses inter alia increased expectations on the part of consumers who are no longer simply content for clothing worn next to the skin, such as lingerie or pantyhose for example, to be comfortable, i.e. not to irritate or redden the skin. On the contrary, consumers also expect such clothing to have a positive effect on the condition of the skin either in both helping to overcome signs of fatigue and imparting a fresh perfume or in avoiding roughness of the skin. Accordingly, there has been no shortage of attempts to finish textiles and especially ladies' pantyhose—which appears to be a particularly attractive consumer sector—with cosmetic active components which are transferred to the skin during wear and produce the desired effects there. Now, it is quite natural that the desired effects are only developed when the corresponding active component is transferred from the clothing to the skin, i.e. no more active component is present on the item of clothing after it has been worn for a more or less long time. This means that the manufacturer of such products has certain requirements to meet when it comes to selecting the active components because—taking into account performance, the quantities that can be applied and, not least, the costs involved—he has to find a compromise which leads to a product of which the effect can be experienced and for which the consumer is prepared to pay an increased price. Since cosmetic active components with the desired effects are generally expensive and since the finishing of the end products also involves additional costs, it is particularly important to the manufacturer that there is no unwanted loss of active components other than by contact between the finished end product and the skin of the wearer, because this would mean that the additional wearing comfort dearly paid for by the consumer would be effective for a shorter time. A particularly unwanted form of loss of active components occurs in the washing of the fibers and fabrics thus finished. Even though such losses cannot be completely avoided, manufacturers of corresponding products are obviously particularly concerned to apply the active components to the fibers in such a way that they are not easily dissolved or mechanically removed.

A solution to this problem lies in the use of microencapsulated active components which are either incorporated as such between the fiber fibrils or are applied to the fibers with the aid of binders. Corresponding systems are known, for example, from EP 0436729 A1, WO 01/098578 A1, U.S. Pat. No. 6,355,263, DE 2318336 A1 and WO 03/093571 (Cognis). However, the disadvantage of microencapsulation is that it introduces an additional complexity into the finishing process and, of course, adds to its cost. However, even more serious is the fact that many capsule types are not sufficiently stable and release the active components too early—in the worst case during the application process itself. Conversely, if encapsulation systems characterized by particularly stable capsules are used instead, the active components may only be released after prolonged mechanical stressing, so that the consumer does not immediately experience the expected wellness effect.

Accordingly, the problem addressed by the present invention was to finish fibers and textiles with suitable active components in such a way that the active components could be applied with minimal effort, would be gradually released during the first wearing and at least 20 to 50% by weight, based on the starting quantity, would still be present on the fibers or textiles after five wash cycles.

### BRIEF DESCRIPTION OF THE INVENTION

The present invention relates to fibers and textile fabrics, characterized in that the fibers and textiles are finished with

(a) hydrophobic active components and
(b) film-forming polymers.

Contrary to the general technical preconception that active components can only be applied to fibers and textiles with some durability if they are microencapsulated beforehand, it has surprisingly been found that hydrophobic active components can be applied even without encapsulation providing they are finely dispersed in polymeric binders of the type which have film-forming properties. The invention includes the observation that, through this so-called composite finishing, generally 10 to 50% by weight of the active component originally applied remains on the fiber, even after 5 to 10 wash cycles, depending on the nature of the binder and the active component. In addition, the absence of microencapsulation ensures that the active components are slowly released during the first wearing and the consumer can also experience the intended effect.

### DETAILED DESCRIPTION OF THE INVENTION

### Active Components

Basically, the choice of the active components is not critical and depends solely on their solubility in water and the effect to be achieved on the skin. The active components preferably have a solubility in water at 20° C. of less than 10 g/l and, more particularly, less than 1 g/l.

Hydrophobic active components which have moisturizing properties, counteract cellulitis and/or have a soothing effect on the skin are preferred. Typical examples are tocopherols, carotene compounds, sterols, ascorbic acid palmitate, (deoxy)ribonucleic acid and fragmentation products thereof, β-glucans, retinol, bisabolol, allantoin, phytantriol, AHA acids, amino acids, ceramides, pseudoceramides, chitosan, menthol, cosmetic oils and oil components, essential oils, vegetable proteins and hydrolysis products thereof, plant extracts, vitamin complexes, insect repellents and nanoized inorganic substances or minerals and mixtures thereof.

TocoPherols

Tocopherols are understood to be chroman-6-ols (3,4-dihydro-2H-1benzopyran-6-ols) substituted in the 2 position by a 4,8,12-trimethyltridecyl group. They are also known as bioquinones. Typical examples are the plastiquinones, tocopherol quinones, ubiquinones, boviquinones, K vitamins and menaquinones (for example 2-methyl-1,4-naphthoquinones). The quinones from the vitamin E series, i.e. α-, β-, γ-, δ- and ε-tocopherol (the last of these still having the original unsaturated prenyl side chain, see FIGURE), are preferably used.

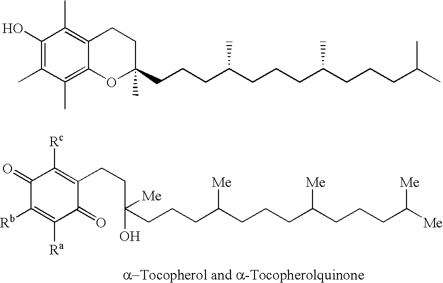

Tocopherol quinones and hydroquinones and esters of the quinones with carboxylic acids, such as acetic acid or palmitic acid for example, are also suitable. It is preferred to use α-tocopherol, tocopherol acetate and tocopherol palmitate and mixtures thereof.

Carotene Compounds

Carotene compounds are essentially understood to be carotenes and carotinoids. Carotenes are a group of 11x to 12x-unsaturated triterpenes. Of particular importance are the three isomeric α-, β- and γ-carotenes which all have the same basic skeleton with 9 conjugated double bonds, 8 methyl branches (including possible ring structures) and a β-ionone structure at one end of the molecule and which were originally regarded as a homogeneous natural material. A number of carotene compounds suitable as component (b) are shown below although the list is by no means complete.

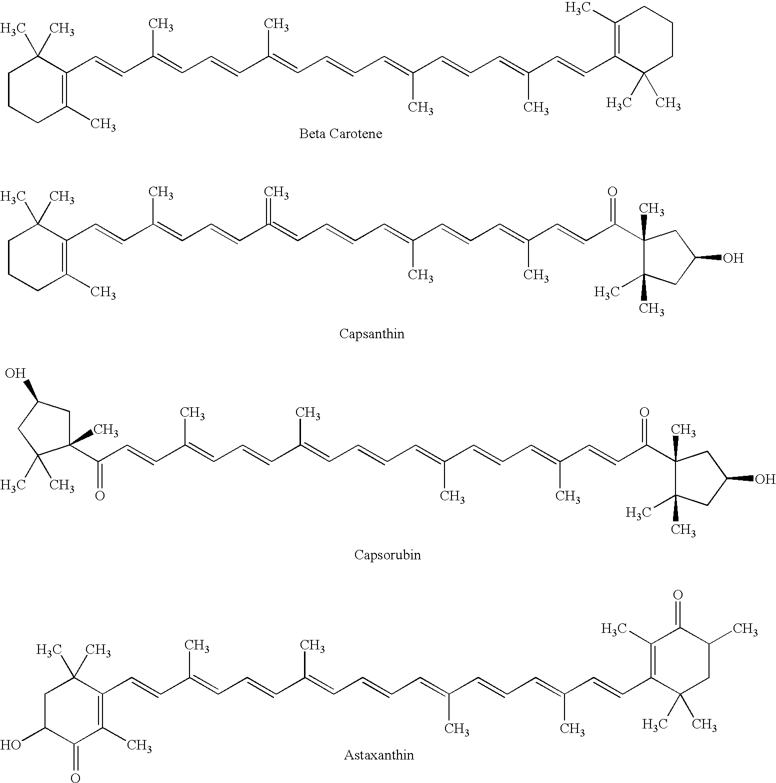

Besides the isomers already mentioned, δ-, ε- and ζ-carotene (lycopene) are also suitable, although β-carotene (provitamin A) is certainly of particular importance by virtue of its wide distribution; in the organism, it is split enzymatically into two retinal molecules. Carotinoids are oxygen-containing derivatives of the carotenes which are also known as xanthophylls and of which the basic skeleton consists of 8 isoprene units (tetraterpenes). The carotinoids may be thought of as being composed of two C₂₀ isoprenopids in such a way that the two central methyl groups are in the 1,6-position to one another. Typical examples are (3R,6′R)-β-ε-caroten-3,3′-diol (lutein), (3R,3′S,5′R)-3,3′-dihydroxy-β,κ-caroten-6-one (capsanthin), 9′-cis-6,6′-diapocarotendiacid-6′-methyl ester (bixin), (3S,3′S,5R,5′R)-3,3′-dihydroxy-κ,κ-caroten-6,6′-dione (capsorubin) or 3S,3′S-3,3′-dihydroxy-β,β′-caroten-4,4′-dione (astaxanthin). Besides the carotenes and carotinoids, carotene compounds in the context of the invention also include cleavage products such as, for example, 3,7-dimethyl-9-(2,6,6-trimethyl-1-cyclohexenyl)-2,4,6,8-nonatetraen-1-ol (retinol, vitamin A1) and 3,7-dimethyl-9-(2,6,6-trimethyl-1-cyclohexenyl)-2,4,6,8-nonatetraenal (retinal, vitamin A1 aldehyde).

Sterols

Sterols—also known as sterins—are steroids which have a hydroxyl group attached to the C3 atom. Sterols typically contain 27 to 30 carbon atoms and a double bond in the ⅚ position. Hydrogenation of the double bond leads to sterols which are often referred to as stanols and which are also encompassed by the present invention. The FIGURE shows the structure of the most well-known sterol, cholesterol, which belongs to the group of zoosterols.

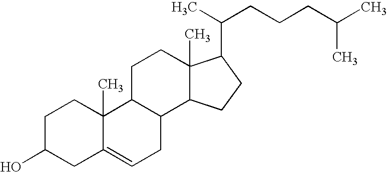

By virtue of their superior physiological properties, the use of vegetable sterols, the so-called phytosterols, is preferred. Examples include ergosterols, stigmasterols and, more particularly, sitosterols and hydrogenation products thereof, the sitostanols. The present invention also encompasses the sterol esters, above all the condensation products of the sterols mentioned with saturated or unsaturated fatty acids containing 6 to 26 carbon atoms and up to 6 double bonds.

Chitosans

Chitosans are biopolymers which belong to the group of hydrocolloids. Chemically, they are partly deacetylated chitins differing in their molecular weights which contain the following—idealized—monomer unit:

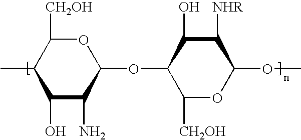

In contrast to most hydrocolloids, which are negatively charged at biological pH values, chitosans are cationic biopolymers under these conditions. The positively charged chitosans are capable of interacting with oppositely charged surfaces and are therefore used in cosmetic hair-care and body-care products and pharmaceutical preparations. Chitosans are produced from chitin, preferably from the shell residues of crustaceans which are available in large quantities as inexpensive raw materials. In a process described for the first time by Hackmann et al., the chitin is normally first deproteinized by addition of bases, demineralized by addition of mineral acids and, finally, deacetylated by addition of strong bases, the molecular weights being distributed over a broad spectrum. Preferred types are those which have an average molecular weight of 10,000 to 500,000 dalton or 800,000 to 1,200,000 dalton and/or a Brookfield viscosity (1% by weight in glycolic acid) below 5,000 mPas, a degree of deacetylation of 80 to 88% and an ash content of less than 0.3% by weight.

Cosmetic Oils and Oil Components

Suitable cosmetic oils and oil components are, for example, Guerbet alcohols based on fatty alcohols containing 6 to 18 and preferably 8 to 10 carbon atoms, esters of linear C₆₋₂₂ fatty acids with linear or branched C₆₋₂₂ fatty alcohols or esters of branched C₆₋₁₃ carboxylic acids with linear or branched C₆₋₂₂ fatty alcohols such as, for example, myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of linear C₆₋₂₂ fatty acids with branched alcohols, more particularly 2-ethyl hexanol, esters of C₁₈₋₃₈ alkylhydroxycarboxylic acids with linear or branched C₆₋₂₂ fatty alcohols, more especially dioctyl malate, esters of linear and/or branched fatty acids with polyhydric alcohols (for example propylene glycol, dimer diol or trimer triol) and/or Guerbet alcohols, triglycerides based on C₆₋₁₀ fatty acids, liquid mono-/di-/triglyceride mixtures based on C₆₋₁₈ fatty acids, esters of C₆₋₂₂ fatty alcohols and/or Guerbet alcohols with aromatic carboxylic acids, more particularly benzoic acid, esters of C₂₋₁₂ dicarboxylic acids with linear or branched alcohols containing 1 to 22 carbon atoms or polyols containing 2 to 10 carbon atoms and 2 to 6 hydroxyl groups, vegetable oils, branched primary alcohols, substituted cyclohexanes, linear and branched C₆₋₂₂ fatty alcohol carbonates, such as dicaprylyl carbonate (Cetiol® CC) for example, Guerbet carbonates based on fatty alcohols containing 6 to 18 and preferably 8 to 10 carbon atoms, esters of benzoic acid with linear and/or branched C₆₋₂₂ alcohols (for example Finsolv® TN), linear or branched, symmetrical or nonsymmetrical dialkyl ethers containing 6 to 22 carbon atoms per alkyl group, such as dicaprylyl ether (Cetiol® OE) for example, ring opening products of epoxidized fatty acid esters with polyols, silicone oils (cyclomethicone, silicon methicone types, etc.) and/or aliphatic or naphthenic hydrocarbons, for example squalane, squalene or dialkyl cyclohexanes.

Nanoized Inorganic Materials and Minerals

“Nanoparticles” are understood by the expert to be particles which, through suitable production processes, have mean particle sizes of 0.01 to 0.1 μm. One such process for the production of nanoparticles by rapid expansion of supercritical solutions (RESS process) is known, for example, from the article by S. Cihlar, M. Turk and K. Schaber in Proceedings World Congress on Particle Technology 3, Brighton, 1998. To prevent the nanoparticles from agglomerating, it is advisable to dissolve the starting materials in the presence of suitable protective colloids or emulsifiers and/or to expand the critical solutions into aqueous and/or alcoholic solutions of the protective colloids or emulsifiers or into cosmetic oils which may in turn contain redissolved emulsifiers and/or protective colloids. Suitable protective colloids are, for example, gelatine, casein, chitosan, gum arabic, lysalbinic acid, starch and polymers, such as polyvinyl alcohols, polyvinyl pyrrolidones, polyalkylene glycols and polyacrylates.

Another suitable process for the production of nanoscale particles is the evaporation technique. Here, the starting materials are first dissolved in a suitable organic solvent (for example alkanes, vegetable oils, ethers, esters, ketones, acetals and the like). The solutions are then introduced into water or another non-solvent, optionally in the presence of a surface-active compound dissolved therein, so that the nanoparticles are precipitated through the homogenization of the two immiscible solvents, the organic solvent preferably evaporating. O/w emsulsions or o/w microemulsions may be used instead of an aqueous solution. The emulsifiers and protective colloids mentioned previously may be used as the surface-active compounds.

Another method for the production of nanoparticles is the so-called GAS process (gas anti-solvent recrystallization). This process uses a highly compressed gas or supercritical fluid (for example carbon dioxide) as non-solvent for the crystallization of dissolved substances. The compressed gas phase is introduced into the primary solution of the starting materials and absorbed therein so that there is an increase in the liquid volume and a reduction in solubility and fine particles are precipitated.

The PCA process (precipitation with a compressed fluid anti-solvent) is equally suitable. In this process, the primary solution of the starting materials is introduced into a supercritical fluid which results in the formation of very fine droplets in which diffusion processes take place so that very fine particles are precipitated.

In the PGSS process (particles from gas saturated solutions), the starting materials are melted by the introduction of gas under pressure (for example carbon dioxide or propane). Temperature and pressure reach near- or super-critical conditions. The gas phase dissolves in the solid and lowers the melting temperature, the viscosity and the surface tension. On expansion through a nozzle, very fine particles are formed as a result of cooling effects.

Another process for the production of the nanoparticles is the GPC or PVS process (gas phase condensation; physical vapor synthesis), in which plasma-vaporized metals are oxidized with oxygen and the subjected to controlled condensation.

According to the present invention, the active components are preferably nanoized zinc oxide which has a surprisingly higher activity against neurodermitis than conventional zinc oxide. Accordingly, the present invention also relates to the use of optionally microencapsulated nanoized zinc oxide for finishing fibers and textiles and for the production of cosmetic and/or pharmaceutical preparations. The zinc oxide nanoparticles typically have mean diameters in the range from 0.1 to 0.2 μm. Titanium dioxide and other nano-metal oxides and nano-mixed oxides, such as ITO and ATO, are also suitable.

From the perspective of the broadest action profile, the use of the following active components is particularly preferred:
tocopherol, tocopherol acetate, tocopherol palmitate,
β-carotene, retinol,
jojoba oil,
vegetable triglycerides, such as coconut oil, palm oil, apricot kernel oil or hazelnut oil,
essential oils,
squalane,
chitosan,
menthol,
vegetable or animal (silk) proteins and hydrolysis products thereof,
N,N-diethyl-3-methylbenzamides (DEET) and
nanoized zinc oxide or titanium dioxide
   because, individually or in combination, they
contribute towards the equilibrium of the cutaneous hydrolipid layer,
prevent water loss and hence wrinkling,
freshen the skin and counteract signs of fatigue,
give the skin a soft and elastic feel,
improve dermal drainage, the supply of nutrients and the circulation,
act against oxidative stress, environmental toxins, ageing of the skin and free radicals,
compensate for the loss of fats caused by water and sun,
counteract cellulitis,
improve the water resistance of UV filters,
accelerate and prolong tanning,
repel or kill insects and, finally, also
have antimicrobial, anti-inflammatory and antineurodermitic properties.

The percentage amount of active components on the finished fibers and textiles, expressed as active substance, is between 0.1 and 10% by weight, preferably between 0.25 and 7.5% by weight and more particularly between 0.5 and 5% by weight.

### Binders

The polymeric, film-forming binders suitable for the purposes of the invention may be selected from the group consisting of

polyurethanes,

polyethyl vinyl acetates,

polymeric melamine compounds,

polymeric glyoxal compounds,

polymeric silicone compounds

epichlorohydrin-crosslinked polyamidoamines,

poly(meth)acrylates and

polymeric fluorocarbons.

Polyurethanes and Polyvinyl Acetates

Suitable polyurethanes (PU) and polyethyl vinyl acetates (EVA) are the commercially available products from the Stabiflex® and Stabicryl® series marketed by Cognis Deutschland GmbH & Co. KG.

Polymeric Melamine Compounds

Melamine (synonym: 2,4,6-triamino-1,3,5-triazine) is normally formed by trimerization of dicyanodiamide or by cyclization of urea with elimination of carbon dioxide and ammonia. Melamines in the context of the invention are understood to be oligomeric or polymeric condensation products of melamine with formaldehyde, urea, phenol or mixtures thereof.

Polymeric Glyoxal Compounds

Glyoxal (synonym: oxaldehyde, ethanedial) is formed in the vapor-phase oxidation of ethylene glycol with air in the presence of silver catalysts. Glyoxals in the context of the present invention are understood to be the self-condensation products of glyoxal (“polyglyoxals”).

Polymeric Silicone Compounds

Suitable silicone compounds are, for example, dimethyl polysiloxanes, methylphenyl polysiloxanes, cyclic silicones and amino-, fatty acid-, alcohol-, polyether-, epoxy-, fluorine-, glycoside- and/or alkyl-modified silicone compounds which may be both liquid and resin-like at room temperature. Other suitable silicone compounds are simethicones which are mixtures of dimethicones with an average chain length of 200 to 300 dimethylsiloxane units and hydrogenated silicates. The use of aminosiloxanes, for example Cognis 3001 from Cognis Deutschland GmbH & Co. KG, is particularly preferred. Their further crosslinking with H-siloxanes, for example Cognis 3002 from Cognis Deutschland GmbH & Co. KG, can further enhance their performance as binders.

Epichlorohydrin-Crosslinked Polyamidoamines

Epichlorohydrin-crosslinked polyamidoamines, which are also known as “fibrabones” or “wet strength resins”, are sufficiently well-known from textile and paper technology. They are preferably produced by two methods:
i) polyaminoamides are (a) initially reacted with a quantity of 5 to 30 mol-%, based on the nitrogen available for quaternization, of a quaternizing agent and (b) the resulting quaternized polyaminoamides are then crosslinked with a molar quantity of epichlorohydrin corresponding to the content of non-quaternized nitrogen, or
ii) polyaminoamides are (a) initially reacted at 10 to 35° C. with a quantity of 5 to 40 mol-%, based on the nitrogen available for crosslinking, of epichlorohydrin and (b) the intermediate product is adjusted to a pH of 8 to 11 and crosslinked at 20 to 45° C. with more epichlorohydrin so that the overall molar ratio is 90 to 125 mol-%, based on the nitrogen available for crosslinking.

Poly(meth)acrylates

Poly(meth)acrylates are understood to be homo- and co-polymerization products of acrylic acid, methacrylic acid and optionally esters thereof, particularly with lower alcohols, such as for example methanol, ethanol, isopropyl alcohol, the isomeric butanols, cyclohexanol and the like, which are obtained in known manner, for example by radical polymerization in UV light. The average molecular weight of the polymers is typically between 100 and 10,000, preferably between 200 and 5,000 and more particularly between 400 and 2,000 dalton.

The binders—expressed as active substance—are applied to the fibers in quantities of typically 0.5 to 15% by weight, preferably 1 to 10% by weight and more particularly 1 to 5% by weight.

### Microcapsules

In a preferred embodiment of the present invention, the fibers and textiles are finished both with hydrophobic unencapsulated active components and with other encapsulated active components using the binders mentioned. In this way, the advantages of both action mechanisms are combined and their disadvantages neutralized. The unencapsulated active components act directly, i.e. during the first wearing, and provide the consumer with the desired wellness effect, but undergo a rapid reduction in content after the tenth wash cycle whereas the microencapsulated active components only then begin to release their active principles, particularly when highly resistant capsule systems are used.

“Microcapsules” or “nanocapsules” are understood by the expert to be spherical aggregates with a diameter of about 0.0001 to about 5 mm and preferably 0.005 to 0.5 mm which contain at least one solid or liquid core surrounded by at least one continuous membrane. More precisely, they are finely dispersed liquid or solid phases coated with film-forming polymers, in the production of which the polymers are deposited onto the material to be encapsulated after emulsification and coacervation or interfacial polymerization. In another process, molten waxes are absorbed in a matrix (“microsponge”) which, as microparticles, may be additionally coated with film-forming polymers. In a third process, particles are alternately coated with polyelectrolytes having different charges (layer-by-layer process) The microscopically small capsules can be dried in the same way as powders. Besides single-core microcapsules, there are also multiple-core aggregates, also known as microspheres, which contain two or more cores distributed in the continuous membrane material. In addition, single-core or multiple-core microcapsules may be surrounded by an additional second, third etc. membrane. The membrane may consist of natural, semisynthetic or synthetic materials. Natural membrane materials are, for example, gum arabic, agar agar, agarose, maltodextrins, alginic acid and salts thereof, for example sodium or calcium alginate, fats and fatty acids, cetyl alcohol, collagen, chitosan, lecithins, gelatin, albumin, shellac, polysaccharides, such as starch or dextran, polypeptides, protein hydrolyzates, sucrose and waxes. Semisynthetic membrane materials are inter alia chemically modified celluloses, more particularly cellulose esters and ethers, for example cellulose acetate, ethyl cellulose, hydroxypropyl cellulose, hydroxypropyl methyl cellulose and carboxymethyl cellulose, and starch derivatives, more particularly starch ethers and esters. Synthetic membrane materials are, for example, polymers, such as polyacrylates, polyamides, polyvinyl alcohol or polyvinyl pyrrolidone.

Examples of known microcapsules are the following commercial products (the membrane material is shown in brackets) Hallcrest Microcapsules (gelatin, gum arabic), Coletica Thalaspheres (maritime collagen), Lipotec Millicapseln (alginic acid, agar agar), Induchem Unispheres (lactose, microcrystalline cellulose, hydroxypropylmethyl cellulose), Unicerin C30 (lactose, microcrystalline cellulose, hydroxypropylmethyl cellulose), Kobo Glycospheres (modified starch, fatty acid esters, phospholipids), Softspheres (modified agar agar), Kuhs Probiol Nanospheres (phospholipids), Primaspheres and Primasponges (chitosan, alginates) and Primasys (phospholipids). Chitosan microcapsules and processes for their production are the subject of earlier patent applications filed by applicants [WO 01/01926, WO 01/01927, WO 01/01928, WO 01/01929].

To produce the microcapsules, a 1 to 10 and preferably 2 to 5% by weight aqueous solution of the gel former, preferably agar agar, is normally prepared and heated under reflux. A second aqueous solution containing the cationic polymer, preferably chitosan, in quantities of 0.1 to 2 and preferably 0.25 to 0.5% by weight and the active substances in quantities of 0.1 to 25 and preferably 0.25 to 10% by weight is added in the boiling heat, preferably at 80 to 100° C.; this mixture is called the matrix. Accordingly, the charging of the microcapsules with active substances may also comprise 0.1 to 25% by weight, based on the weight of the capsules. If desired, water-insoluble constituents, for example inorganic pigments, may be added at this stage to adjust viscosity, generally in the form of aqueous or aqueous/alcoholic dispersions. In addition, to emulsify or disperse the active substances, it can be useful to add emulsifiers and/or solubilizers to the matrix. After its preparation from gel former, cationic polymer and active substances, the matrix may optionally be very finely dispersed in an oil phase with intensive shearing in order to produce small particles in the subsequent encapsulation process. It has proved to be particularly advantageous in this regard to heat the matrix to temperatures in the range from 40 to 60° C. while the oil phase is cooled to 10 to 20° C. The actual encapsulation, i.e. formation of the membrane by contacting the cationic polymer in the matrix with the anionic polymers, takes place in the last, again obligatory step. To this end, it is advisable to wash the matrix optionally dispersed in the oil phase with an aqueous ca. 1 to 50 and preferably 10 to 15% by weight aqueous solution of the anionic polymer and, if necessary, to remove the oil phase either at the same time or afterwards. The resulting aqueous preparations generally have a microcapsule content of 1 to 10% by weight. In some cases, it can be of advantage for the solution of the polymers to contain other ingredients, for example emulsifiers or preservatives. After filtration, microcapsules with a mean diameter of preferably about 0.01 to 1 mm are obtained. It is advisable to sieve the capsules to ensure a uniform size distribution. The microcapsules thus obtained may have any shape within production-related limits, but are preferably substantially spherical. Alternatively, the anionic polymers may also be used for the preparation of the matrix and encapsulation may be carried out with the cationic polymers, especially the chitosans.

Alternatively, encapsulation may be carried out using only cationic polymers and utilizing their property of coagulating at pH values above the pKs value.

A second alternative process for the production of the microcapsules according to the invention comprises initially preparing an o/w emulsion which, besides the oil component, water and the active components, contains an effective quantity of emulsifier. To form the matrix, a suitable quantity of an aqueous anionic polymer solution is added to this preparation with vigorous stirring. The membrane is formed by addition of the chitosan solution. The entire process preferably takes place at a mildly acidic pH of 3 to 4. If necessary, the pH is adjusted by addition of mineral acid. After formation of the membrane, the pH is increased to a value of 5 to 6, for example by addition of triethanolamine or another base. This results in an increase in viscosity which can be supported by addition of other thickeners such as, for example, polysaccharides, more particularly xanthan gum, guar guar, agar agar, alginates and tyloses, carboxymethyl cellulose and hydroxyethyl cellulose, relatively high molecular weight polyethylene glycol mono- and diesters of fatty acids, polyacrylates, polyacrylamides and the like. Finally, the microcapsules are separated from the aqueous phase, for example by decantation, filtration or centrifuging.

In a third alternative process, the microcapsules are formed around a preferably solid, for example crystalline, core by coating this core in layers with oppositely charged polyelectrolytes, cf. European patent EP 1064088 B1 (Max-Planck Gesellschaft).

Other processes for the production of PVMMA-based microcapsules are described in DE 3512565 A1 (BASF) and in U.S. Pat. No. 4,089,802 (NCR Corp.). In these known processes, aqueous polyacrylate solutions, for example, are mixed with paraffins and a precondensate of melamine and formaldehyde is then added.

### Commercial Applications

The preparations of hydrophobic active components and film-forming polymers are used for finishing fibers and all kinds of textile fabrics, i.e. both end products and semifinished products, during or even after the production process in order thus to improve wearing comfort on the skin. The choice of the materials of which the fibers or textiles consist is very largely uncritical. Suitable materials are any standard natural and synthetic materials and blends thereof, but especially cotton, polyamides, polyesters, viscose, polyamide/elastane, cotton/elastane and cotton/polyester. The choice of the textile is equally uncritical, although it is logical to finish products which are in direct contact with the skin, i.e. in particular underwear, swimwear, nightwear, hose and pantyhose.

### Application Processes

The present invention also relates to a first process for finishing fibers or textile fabrics, in which the substrates are impregnated with aqueous preparations containing the hydrophobic active components and the film-forming polymers and optionally other microencapsulated active components and emulsifiers. Impregnation of the fibers or textiles may be carried out, for example, by the so-called exhaust method. This may be carried out in a commercially available washing machine or in a dyeing machine typically used in the textile industry.

Alternatively, the present invention also relates to a second process for finishing fibers and textile fabrics in which the aqueous preparations containing the hydrophobic active components and the film-forming polymers and optionally other microencapsulated active components and emulsifiers are applied by pressure application. In this process, the fibers/fabrics to be treated are drawn through an immersion bath containing the microencapsulated active components and the binders, the preparations being applied under pressure in a press. This technique is known as padding

The concentration of active components is normally from 0.5 to 15 and preferably from 1 to 10% by weight, based on the liquor or the immersion bath. Impregnation generally requires lower concentrations than pressure application to charge the fibers or textile fabrics with the active components.

Finally, the present invention relates to the use of mixtures containing

(a) hydrophobic active components,
(b) film-forming active components and optionally
(c) other microencapsulated active components
for finishing fibers and textile fabrics.

### EXAMPLES

### Example 1

An active component mixture of Monoi de Tahiti (refined coconut oil with active principles of the Tiara flower) and vitamin E in a ratio by weight of 9:1 was mixed with various polymeric binders (Stabiflex:polyurethane, Cognis 3001, 3002=polysiloxanes) and the resulting mixture was applied by pressure application to cotton fabric. Based on active substance and fiber weight, the active components were used in a quantity of 1% by weight and the binders in a quantity of 3% by weight. All fabric samples were dried for 2 mins. at 140° C. The cotton fabric was washed a total of 10 times in a conventional washing machine at 40° C. and the quantity of active component remaining on the fibers was determined after various wash cycles. The results (rounded average values from three test series) are set out in Table 1:

TABLE 1
Washing tests

| | Binder | |
|---|---|---|
| | Stabiflex ® Ni (PU) | Cognis 3001/Cognis 3002 (95/5) |
| Monoi [%] | | |
| Unwashed | 100 | 100 |
| After 1 wash | 76 | 90 |
| After 5 washes | 50 | 78 |
| After 10 washes | 39 | 54 |
| Vitamin E [%] | | |
| Unwashed | 100 | 100 |
| After 1 wash | 98 | 90 |
| After 5 washes | 79 | 68 |
| After 10 washes | 65 | 55 |

### Example 2

Example 1 was repeated using a polyamide/Lycra (90:10) blend instead of cotton. The results (rounded average values from three test series) are set out in Table 2:

TABLE 2
Washing tests

| | Binder | |
|---|---|---|
| Vitamin E [%] | Stabiflex ® Ni (PU) | Cognis 3001/Cognis 3002 (95/5) |
| Unwashed | 100 | 100 |
| After 1 wash | 75 | 89 |
| After 5 washes | 66 | 77 |
| After 10 washes | 53 | 69 |

### Example 3

A technical sterol mixture (Generol® R, Cognis Deutschland GmbH & Co. KG) was mixed with various polymeric binders and applied by pressure application to a polyamide/Lycra blend. Based on active substance and fiber weight, the sterols were used in a quantity of 1% by weight and the binders in a quantity of 3% by weight. All fabric samples were dried for 2 minutes at 140° C. The fabric was washed a total of 10 times in a conventional washing machine at 40° C. and the quantity of sterol remaining on the fibers was determined after various wash cycles. The results (average values from three test series) are set out in Table 3:

TABLE 3
Washing tests

| | Binder | |
|---|---|---|
| Sterols [%] | Stabiflex ® Ni (PU) | Stabicryl ® 1009 (EVA) |
| Unwashed | 100 | 100 |
| After 1 wash | 95 | 82 |
| After 5 washes | 83 | 69 |
| After 10 washes | 66 | 58 |

### Examples 4 to 9

To produce the nanoscale metal oxides (Examples 4 to 8), carbon dioxide was first taken from a reservoir under a constant pressure of 60 bar and was purified in a column with an active carbon and a molecular sieve packing. After liquefaction, the CO₂ was compressed to the required supercritical pressure p by a diaphragm pump at a constant delivery rate of 3.5 l/h. The solvent was then brought to the necessary temperature T1 in a preheater and was introduced into an extraction column (steel, 400 ml) charged with the metal soaps. The resulting supercritical, i.e. fluid, mixture was sprayed through a laser-drawn nozzle (length 830 μm, diameter 45 μm) at a temperature T2 into a Plexiglas expansion chamber containing a 4% by weight aqueous solution of an emulsifier or protective colloid. The fluid medium evaporated, leaving the dispersed nanoparticles encapsulated in the protective colloid behind. To produce the nanoparticles in accordance with Example 9, a 1% by weight dispersion of zinc oxide was added dropwise with intensive stirring to a 4% by weight aqueous solution of Coco Glucosides at 40° C. and under a reduced pressure of 40 mbar. The evaporating solvent was condensed in a cold trap while the dispersion containing the nanoparticles remained behind. The process conditions and the average particle size range (PSR, as determined photometrically by the 3-WEM method) are set out in Table 4 below.

TABLE 4
Nanometal oxides

| | | | p | T1 | T2 | Emulsifier/Protective | PSR |
|---|---|---|---|---|---|---|---|
| Ex. | Metal oxides | Solv. | bar | ° C. | ° C. | Colloid | nm |
| 4 | Zinc oxide | CO₂ | 200 | 85 | 175 | Polyvinyl alcohol | 60-120 |
| 5 | Zinc oxide | CO₂ | 180 | 70 | 160 | Polyethylene glycol (M = 400) | 75-120 |
| 6 | Zinc oxide | CO₂ | 200 | 85 | 180 | Polyvinyl alcohol | 75-130 |
| 7 | Titanium dioxide | CO₂ | 200 | 85 | 175 | Polyvinyl alcohol | 60-140 |
| 8 | Titanium dioxide | CO₂ | 200 | 85 | 175 | Coco Glucosides | 55-140 |
| 9 | Zinc oxide | — | — | — | — | Coco Glucosides | 60-130 |

### Example 10

Nanoized zinc oxide (particle diameter 0.1-0.2 μm) dispersed in water was mixed with various polymeric binders and applied by pressure application to a polyamide/Lycra blend. Based on active substance and fiber weight, the zinc oxide was used in a quantity of 1% by weight and the binders in a quantity of 1% by weight. All fabric samples were dried for 2 minutes at 140° C. They were then washed a total of 10 times in a conventional washing machine at 40° C. and the quantity of zinc oxide remaining on the fibers was determined after various wash cycles. The results (average values from three test series) are set out in Table 5:

TABLE 5
Washing tests

| | Binder | |
|---|---|---|
| Nano-ZnO [%] | Stabiflex ® Ni (PU) | Cognis 3001/Cognis 3002 (95/5) |
| Unwashed | 100 | 100 |
| After 1 wash | 31 | 68 |
| After 5 washes | 9 | 35 |
| After 10 washes | 6 | 29 |

### Example 11

An unencapsulated vitamin E and microencapsulated vitamin E (Primaspheres, Cognis Iberia S.L.) were mixed with various polymeric binders and applied by pressure application to cotton fabric. Based on active substance and fiber weight, the active components were used in a quantity of 1% by weight and the binders in a quantity of 3% by weight. The cotton fabric was washed a total of 10 times in a conventional washing machine at 40° C. and the quantity of active component remaining on the fibers was determined after various wash cycles. The results (average values from three test series) are set out in Table 6:

TABLE 6
Washing tests

| | Binder | |
|---|---|---|
| Vitamin E [%] | Stabiflex ® Ni (PU) | Cognis 3001/Cognis 3002 (95/5) |
| Unwashed | 100 | 100 |
| After 1 wash | 82 | 89 |
| After 5 washes | 61 | 70 |
| After 10 washes | 45 | 52 |

We claim:

1. Fibers and textile fabrics, finished with a mixture comprising:
(a) hydrophobic active component and
(b) a film-forming polymer binder.

2. Fibers and textile fabrics as claimed in claim 1, wherein, the active components comprise at least one member selected from the group consisting of tocopherols, carotene compounds, sterols, ascorbic acid, (deoxy)ribonucleic acid and fragmentation products thereof, β-glucans, retinol, bisabolol, allantoin, phytantriol, AHA acids, amino acids, ceramides, pseudoceramides, chitosan, menthol, cosmetic oils and oil components, essential oils, vegetable proteins, hydrolysis products of vegetable proteins, plant extracts, vitamin complexes, insect repellents, nanoized inorganic substances, nanoized minerals and mixtures thereof.

3. Fibers and textile fabrics as claimed in claim 1 containing the active components, expressed as active substance, an amount of 0.1 to 10% by weight.

4. Fibers and textile fabrics as claimed in claim 1, wherein, the binders comprise a member selected from the group consisting of polyurethanes, polyvinyl acetates, polymeric melamine compounds, polymeric glyoxal compounds, polymeric silicone compounds, epichlorohydrin-crosslinked polyamidoamines, poly(meth)acrylates and polymeric fluorocarbons and mixtures thereof.

5. Fibers and textile fabrics as claimed in claim 1, containing the binders, expressed as active substance, in an amount of 0.5 to 15% by weight.

6. Fibers and textile fabrics as claimed in claim 1, wherein, the mixture additionally comprises microencapsulated active components as component (c).

7. A process for finishing fibers or textile fabric substrates which comprises: impregnating the substrate with an aqueous mixture containing hydrophobic active components, film-forming polymers and optionally microencapsulated active components by an exhaustion method.

8. A process for finishing fibers and/or textile fabric substrate which comprises: applying an aqueous mixture containing hydrophobic active components, film-forming polymers and optionally microencapsulated active components to the substrate by pressure application.

9. A composition for finishing fibers and textile fabrics comprising a mixture containing:
(a) a hydrophobic active component;
(b) a film-forming polymer; and optionally
(c) microencapsulated active components, whereby,
the wearing comfort of the finished fibers and textile fabrics is improved.

10. The composition of claim 9, wherein, the active component and/or microencapsulated active component comprises nanoized zinc and/or titanium dioxide.

11. The composition as claimed in claim 10, wherein, the nanoized zinc and/or titanium dioxide is/are microencapsulated.

12. The fibers or textile fabrics of claim 1, wherein, the hydrophobic active component has a solubility in water of less than 10 g/l at 20° C.

13. The composition of claim 9, wherein, the hydrophobic active component has a solubility in water of less than 10 g/l at 20° C.

14. The finished fibers and textile fabrics of claim 1 containing from 0.5 to 5% by weight of the active component.

15. The fibers and textile fabrics of claim 1, wherein, the fibers and textile fabrics were finished by application of from 0.5 to 15% by weight of the binder in the form of the mixture.

16. The fibers and textile fabrics of claim 1, wherein, the mixture comprises from 0.5% to 15% by weight of the active component.

17. The mixture of claim 9 containing from 0.5% to 15% by weight of the hydrophobic active component.
